(19) United States
(12) Patent Application Publication
(10) Pub. No.: US 2026/0163073 A1
(43) Pub. Date: Jun. 11, 2026

(54) METHOD TO FILL OXYGEN IN A NIMH BATTERY

(71) Applicant: Nilar International AB, Täby (SE)

(72) Inventor: Yang SHEN, Gävle (SE)

(73) Assignee: Nilar International AB, Täby (SE)

(21) Appl. No.: 18/707,482

(22) PCT Filed: Oct. 31, 2022
(86) PCT No.: PCT/SE2022/050993

§ 371 Date: May 3, 2024

(30) Foreign Application Priority Data
Nov. 5, 2021 (SE) 2151354-4

(51) Int. Cl. H01M 10/42; H01M 10/30; H01M 10/48

(52) U.S. Cl. CPC H01M 10/4235; H01M 10/30; H01M 10/482; H01M 10/486; H01M 2300/0014

(57) ABSTRACT

A method for filling oxygen into a NiMH battery module (1) comprising one battery cell (2), the battery module having a casing (4) encompassing the battery cell and a gas space, wherein each battery cell (2) comprises a first electrode, a second electrode, a porous separator, and an aqueous alkaline electrolyte arranged between the first electrode and the second electrode, wherein the casing (4) f comprises an inlet (25) for adding oxygen to the gas space of the battery cell (2). The method comprises monitoring (S72) battery module temperature and initiating filling of oxygen at an initial flow rate; and regulating the oxygen filling flow rate based on the monitored battery module temperature to avoid exceeding an upper temperature limit.

### TECHNICAL FIELD

The present invention relates generally to the field of reconditioning battery cells, especially metal hydride battery cells. The method relates to a method to fill oxygen in NiMH batteries. Furthermore, the present invention relates specifically to the field of increasing the life time of the battery module.

### BACKGROUND ART

Nickel metal hydride (NiMH) batteries have long cycle life and have rapid charge and discharge capabilities. During charge and discharge the electrodes interact with each other through the alkaline electrolyte as hydrogen is transported in the form of water molecules between the electrodes. During discharge hydrogen is released from the negative electrode and is allowed to migrate to the positive electrode (nickel electrode) where it intercalates. This binding result in energy is released. During charging the hydrogen migration is reversed.

Especially NiMH batteries are designed to be nickel electrode limited with a starved electrolyte. This is done in order to be able to avoid over charge and over discharge states of the battery cells by controlling the battery cell chemistry and state-of-charge via the gas phase.

When the battery cell is charged, hydrogen is transported from the nickel hydroxide to the metal hydride by water molecules in the aqueous alkaline electrolyte. During discharge hydrogen is transported back to the nickel hydroxide electrode, again in the form of water molecules.

The PCT publication WO 2017/069691 describes that a proper balance of the nickel electrode capacity with respect to the metal hydride electrode capacity with suitable amounts of both overcharge- and over discharge-reserves are essential for a well-functioning battery module, enabling it to reach a stable long time charge/discharge performance. Adding oxygen gas, hydrogen gas or hydrogen peroxide provides a suitable overcharge and discharge reserve and replenishes the electrolyte, which prolongs the lifetime of the battery module and increases the number of possible cycles.

The adding of oxygen is preferably performed when the battery module is not in operation. Thus, in order to optimize the operation of the battery module, filling of oxygen should preferably be done in a way that optimizes not only the capacity of the battery module but also the operating time.

In an article with the title “Increasing NiMH Battery Cycle Life with Oxygen” by Shen Yang et al, published in International Journal of Hydrogen Energy, 2018 Mar. 29, ISSN 0360-3199, Vol 43, No 40, pp 18626-18631, a study is disclosed wherein a controlled addition of oxygen was used to rebalance the electrodes and replenish the electrolyte in a NiMH battery.

Furthermore, in the published PCT application WO2021/01749 A1, assigned to Nilar International AB, some boundary conditions have been identified to reduce the risk of fire during refilling oxygen. However, there is a need to further improve the filling of oxygen to optimize the performance of the NiMH battery.

### SUMMARY OF THE INVENTION

An objective of the present invention is to provide a method for filling oxygen into a battery module comprising at least one nickel metal hydride, NiMH, battery cells, which at least alleviates the drawbacks of the prior art.

The object of the invention is achieved by means of a method for filling oxygen into a nickel metal hydride, NiMH, battery module comprising at least one battery cell, the battery module having a casing encompassing the at least one battery cell and a gas space, wherein each battery cell in the battery module comprises a first electrode, a second electrode, a porous separator, and an aqueous alkaline electrolyte arranged between the first electrode and the second electrode, wherein the porous separator, the first electrode and the second electrode are configured to allow exchange of hydrogen and oxygen by allowing gas to migrate between the electrodes, and wherein the casing further comprises an inlet for adding oxygen to the gas space of the at least one battery cell; wherein the method comprises the steps of
regularly determining present internal resistance of the at least one battery cell of the battery module to calculate a resistance ratio, R, in relation to an initial internal resistance of the at least one battery cell of the battery module; and
filling the battery module with oxygen when the resistance ratio, R, is higher than a maximum value, Rmax; wherein the method is further comprises the steps of:
monitoring (S72) battery module temperature and initiating filling of oxygen at an initial flow rate; and
regulating the oxygen filling flow rate based on the monitored battery module temperature to avoid exceeding an upper temperature limit.

An advantage with the present invention is that the amount of oxygen needed to increase the cycle life of the NiMH battery is reduced compared to prior art method. Further, a maximum filling flow rate can be applied without running the risk of over-heating the battery module.

A further advantage is that the cycle life of the NiMH battery module is increased with less amount of oxygen.

According to one embodiment, the battery module comprises multiple battery cells and the gas space of each battery cell are in gaseous connection to form a common gas space and the inlet is configured to add the gas to the common gas space.

According to one embodiment, the step of filling the battery module with oxygen is performed when the resistance ratio, R, is equal to, or less than, 2.

According to one embodiment, the method further comprises:
monitoring an internal pressure in the at least one battery cell when filling the battery module with oxygen; and
regulating the oxygen filling flow rate based on the monitored internal pressure to avoid exceeding an upper pressure limit.

According to one embodiment, the upper pressure limit is 3 bar.

According to one embodiment, the method further comprises interrupting the step of filling the battery module with oxygen when the oxygen flow rate is regulated to a level corresponding to less than 10% of the initial flow rate; and restarting the step of filling the battery module with oxygen when the battery module temperature is less than 90% of the upper temperature limit.

The object of the invention is also achieved by means of a computer program for reconditioning a battery module, comprising instructions which, when executed on at least one processor, cause the at least one processor to carry out the method according to the invention.

The object of the invention is also achieved by means of a computer-readable storage medium carrying a computer program for reconditioning a battery module according to the invention.

Further advantages of the invention are provided from the description.

In the following preferred embodiments of the invention will be described with reference to the drawings.

### BRIEF DESCRIPTION OF THE DRAWINGS

FIG. 1 shows a battery system for reconditioning battery cells in a battery module.

FIG. 2 shows a flow diagram over a method, according to an embodiment, for reconditioning battery cells in the battery module.

FIG. 3 shows a diagram illustrating resistance ratio as a function of number of refills.

FIG. 4 shows a diagram illustrating resistance ratio as a function of total cycle life.

FIG. 5 shows a diagram illustrating resistance ratio as a function of prolonged cycle number per liter oxygen.

FIG. 6 shows a diagram illustrating resistance ratio as a function of oxygen cost per prolonged cycle.

FIG. 7 shows a diagram illustrating the flow rate of oxygen when filling oxygen into a battery pack, which reveals that the flow rate may influence the performance of the battery pack.

### DETAILED DESCRIPTION

In the following description of preferred embodiments reference will be made to the drawings. The drawings are not drawn to scale and some dimensions may be exaggerated in order to clearly show all features. The same reference numeral will be used for similar features in the different drawings.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

In the application, the term indicative parameter related to the internal resistance of the battery module, comprises the internal resistance as well as a state of health, SOH, measure of the battery module. The SOH measure may include the internal resistance and other parameters that are important to determine the condition of the battery module, such as the internal gas pressure.

The term “internal resistance”, which should be interpreted as the internal DC resistance, is commonly used in the description as a measure of the status of each battery module, and thus the battery cells. The internal resistance is obtained by measuring the voltage drop during a controlled discharge using a predetermined discharge current. The internal resistance is thereafter calculated based on the measured voltage drop and the discharge current. An example is found in the following standard IEC 63115-1, Ed. 1.0 (2020 January), chapter 7.6.3 Measurement of the internal DC resistance.

Some of the example embodiments presented herein are directed towards a method for reconditioning battery cells, especially battery cells having a metal hydride, MH, electrode. An example of such a battery cell is a NiMH battery cell. As part of the development of the example embodiments presented herein, a problem will first be identified and discussed.

During charge and discharge of a NiMH battery module comprising multiple battery cells, the performance of each battery cell will deteriorate due to electrolyte dry out. It has been found that the addition of gas restores the electrode balance resulting in that the internal gas pressure decreases since the gas recombination is improved. Thus, the battery module becomes less sensitive to unintentional overcharging and over discharging. The starved electrolyte design means that only a minimal amount of electrolyte is available in the battery module. Any loss of electrolyte will impair performance mainly manifested in an increased internal resistance. Electrolyte dry-out is the main cause for limiting the cycle life. The electrolyte dry-out is mainly caused by either excessive internal battery cell pressure, which may open the safety valve releasing either oxygen or hydrogen gas dependent upon abusive overcharge or over discharge. When two or more battery cells are gaseously connected, the battery cells will lose electrolyte unevenly. This may be extended to be valid also for battery modules sharing a common gas space.

The main reason for this is that the battery cells are unevenly charged since they are not 100% identical. This will cause some cells to heat up before others, and water (in the form of gas) migrates between the gaseously connected battery cells and condensate where it is less warm. Thus, water move within battery modules. Thus, one of the battery cells will exhibit a faster increase in internal resistance compared to other battery cells. The increase in internal resistance may lead to a decreased lifetime of the battery module.

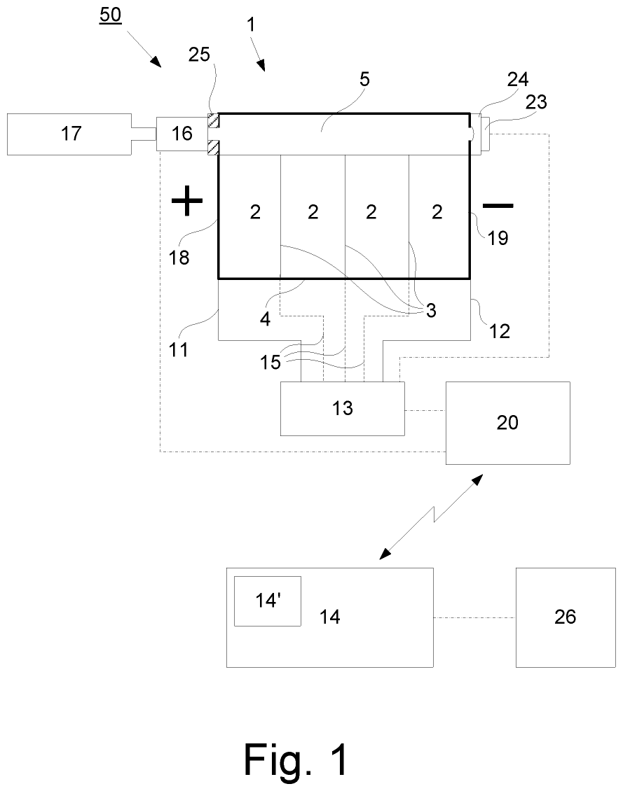

FIG. 1 shows a battery system 50 for conditioning a battery module 1 comprising battery cells 2, which are series connected with biplates 3, to form a stack of battery cells. The battery module 1 has a casing 4 containing the battery cells and enclosing a common gas space 5. Each battery cell 2 in the battery module 1 comprises a first positive electrode, a second negative electrode, a porous separator, and an aqueous alkaline electrolyte arranged between the first electrode and the second electrode. The separator, the first electrode and the second electrodes are configured to allow exchange of hydrogen and oxygen by allowing gas to migrate between the two electrodes. The battery module 1 comprises a positive endplate 18 and a negative endplate 19, which are in contact with the respective end of the stack of battery cells 2. The battery module 1 also comprises a positive terminal connector 11, which is connected to the positive endplate 18, and a negative terminal connector 12, which is connected to the negative endplate 19. The battery casing further comprises a gas inlet 25 for adding a gas or a liquid to the common gas space 5 of the casing 4. The positive terminal connector 11 and the negative terminal connector 12 constitutes terminals from which electric power may be drawn from the battery module 1. Also shown in FIG. 1 is a measuring unit 13, which is connected to the positive terminal connector 11 and to the negative terminal connector 12, and which is configured to obtain data necessary to calculate an indicative parameter related to the internal resistance of the battery module 1 between the positive terminal connector 11 and the negative terminal connector 12. The data obtained by the measuring unit 13 may comprise voltage drop during discharge to determine the internal resistance, temperature, internal pressure, and current in case a current sensor is included within the measuring unit 13. The measuring unit 13 may also be configured to measure the open circuit voltage, OCV, between the positive terminal connector 11 and the negative terminal connector 12. As an alternative it would be possible to connect the measuring unit 13 to obtain the data for only one battery cell 2 as is indicated by the dashed lines 15. However, is very costly to manufacture a battery module with this functionality. An inlet valve 16 is connected to the gas inlet 25. In FIG. 1 an optional gas container 17 is connected to the inlet valve 16. A local control unit 20 is connected to the measuring unit 13 and to the inlet valve 16, and the local control unit may be configured to calculate the indicative parameter based on the data provided from the measuring unit 13. A safety valve 24, e.g. a bursting disc, is connected to the common space 5. The safety valve 24 prevents dangerous gas pressures to build up in the common gas space 5. A pressure sensor 23 may also be connected to the common gas space 5 and is configured to measure the internal pressure in the common gas space 5. An example of a standalone NiMH battery module is disclosed in WO 2007/093626 assigned to the present applicant.

In FIG. 1 is also shown a local control unit 20, which is connected to the pressure sensor 23, the inlet valve 16 and to the measuring unit 13. The local control unit 20 is in communication with a control unit 14, preferably wirelessly connected. It is of course possible to have the local control unit 20 connected to the control unit 14 by wire. It is also possible to have one or more intermediate units in between the local control unit 20 and the control unit 14. It is also possible to omit the local control unit and have the control unit 14 connected to the inlet valve 16 and to the measuring unit 13. The control unit 14 may be located at a remote location such as at, e.g., the battery module manufacturer. The central control unit 14 is connected to or comprises a memory 26.

The control unit 14 is configured to initiate measurements with the measuring unit 13, at predetermined intervals, of temperature, pressure, voltages and currents needed to calculate the indicative parameters, such as internal resistance between the positive terminal connector 11 and the negative terminal connector 12, of the battery module and to send this information to the control unit 14 together with information identifying the battery module 1. To this end the control unit 14 sends a request to the local control unit 20, which returns as answer the current indicative parameter and the open circuit voltage over the battery module. The internal resistance is not directly measured by the measuring unit 13. The measuring unit 13 measures the voltage drop over the battery modules 1 during a discharge with a predetermined discharge current and then the internal resistance is calculated.

During use of the battery module 1, the battery module is discharged and charged. The internal resistance of the battery module increases for an increasing number of charges and discharges.

Although FIG. 1 illustrates a battery module 1 with battery cells in a bipolar configuration, the invention should not be limited to bipolar configurations. Battery cells arranged in other types of configuration, such as cylindrical configuration or prismatic configuration, may benefit from the invention provided a common gas space is provided for a plurality of battery cells in the battery module.

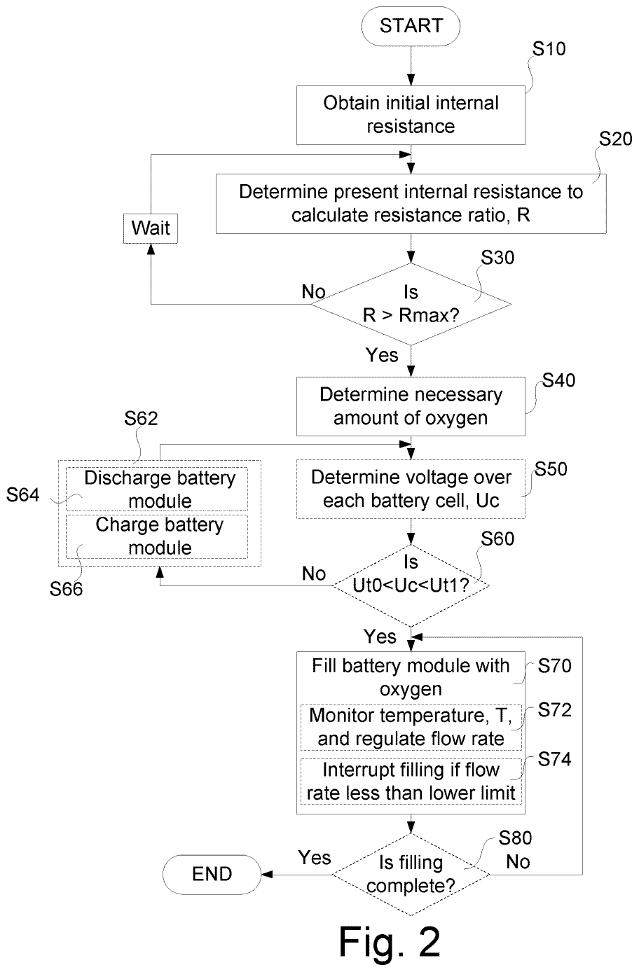

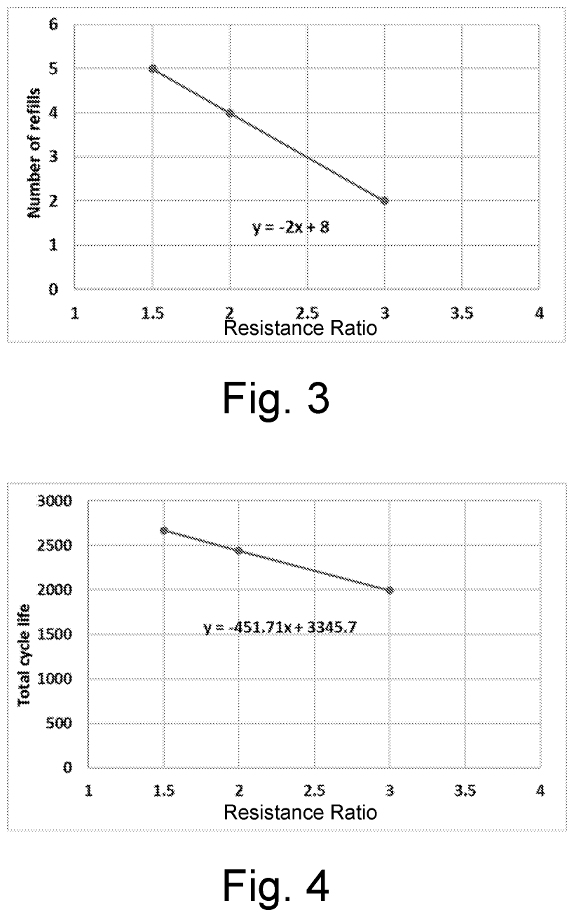

The present invention is based on the knowledge that filling of oxygen into a NiMH battery must also be performed during a certain age interval to keep the performance of the batteries at a certain level. A suitable interval and criteria are for used for indicating when to fill and experimental results are shown in FIGS. 3-7 and a process is disclosed in connection with FIG. 2. Batteries at different age state with resistance ratio 1.5, 2 and 3 (ratio refers to. i.e., 1.5, 2 and 3 times the initial resistance.) have been filled with oxygen gas after cycling. Result of them is displayed in table 1.

TABLE 1

| | | Total | |
|---|---|---|---|
| | | oxygen | |
| Resistance | Number | amount/ | Total cycle |
| ratio, R | of refills | liter | life(@0.8° C.) |
| 3 | 3 | 25.12 | 1992 |
| 2 | 4 | 25.71 | 2438 |
| 1.5 | 5 | 23.29 | 2671 |

The initial cycle life of the battery is when the battery is cycled to resistance ratio 3, which is around 700 cycles. At resistance ratio 3, the battery is at the end of life, filling of oxygen can be repeated 3 times and total cycle is 1992 cycles. When resistance ratio is 2, filling of oxygen can be repeated 4 times and total cycle of the battery is increased to 2438 cycles. For a battery with resistance ratio 1.5, the filling of oxygen can be repeated 5 times and total cycle life can be further prolonged to 2671 cycles. The required total amount of oxygen to restore batteries at different age state with resistance ratios at 2 and 3 are very close (around 25 liter). However, at an age state with resistance ratio of 1.5, the required amount of oxygen is reduced by approximately 8-10% compared to resistance ratios at 2 or 3. Therefore, less oxygen volume cost per prolonged cycle for the battery is achieved when refilled at lower resistance ratio. The experimental results indicates that, more cycle life can be achieved if gas refill is done at a resistance ratio equal to, or lower than, 2. Although gas refill can restore electrolyte and electrode balance of aged batteries, damage or corrosion of electrodes during cycling is unrevivable. Therefore, to keep the performance of batteries more stable over time, filling of oxygen can be repeated more frequently at earlier age state of batteries to prolong cycle life.

FIG. 2 shows a flow diagram of a method for filling the battery module 1 with oxygen. The method comprises the first step S10 of obtaining an initial resistance value Rᵢ of the battery module 1. This may be done in one of many different ways. An example on how the initial resistance value may be obtained is that the local control unit 20 sends a unique identification number to the control unit 14. The control unit 14 may then retrieve data on the battery module from the memory 26. In a second step S20 the present internal resistance of at least one of the battery cells 2, is obtained during cycling. According to one embodiment, data to calculate the internal resistance is obtained from the measuring unit 13, and a control circuitry (e.g. the local control unit 20) determines the present internal resistance between the positive terminal connector 11 and the negative terminal connector 12. The present internal resistance may in this case be determined as an average internal resistance per battery cell or as the total internal resistance over all battery cells of the battery module. According to an alternative embodiment, the measuring unit 13 obtains data to calculate the present internal resistance over each battery cell (as indicated by dashed lines 15 in FIG. 1). The present internal resistance will in this case be determined as the present internal resistance per battery cell. In this example, the local control unit 20 then sends the result of the resistance determination to the control unit 14. The resistance ration R is thereafter calculated by taking the present internal resistance, Rₚ and divide it by the initial internal resistance Rᵢ, R=Rₚ/Rᵢ.

In a third step S30 the control unit 14 determines whether the resistance ratio R exceeds a predetermined maximum resistance ratio Rmax. As an example, Rmax may be selected to be two, i.e. the present internal resistance is twice as high as the initial internal resistance Rᵢ. Rmax may be stored in the memory 26 or be implemented in the method, i.e. in a computer program controlling the execution of the method. In case the resistance ratio R does not exceed the predetermined maximum resistance ratio Rmax, the control unit 14 waits during a waiting time T_{w} for the next resistance determination.

In case the resistance ratio R exceeds the predetermined maximum resistance ratio Rmax, the control unit 14 determines in a fourth step S40 the amount of oxygen to be filled into the battery module 1, based on the obtained internal resistance Rᵢ and the data on the battery module 1, in order to reduce the internal resistance of the battery module 1. The data used in the determination of the necessary amount of oxygen preferably comprises information on the capacity of each battery cell 2, and optionally the volume of the common gas space 5. The necessary amount of oxygen may be determined in many different ways.

According to one alternative embodiment the control unit 14 relies on earlier measurements to obtain the necessary amount of oxygen to be filled into the common space 5 of the of the battery module 1. The control unit 14 may consult a look-up table in the memory 26 to retrieve the data on the battery corresponding to the identification number of the battery module. The data on the battery may in one example be a type number identifying the type of battery. The control unit 14 may then retrieve from a different look-up table the necessary amount of oxygen based on the determined internal resistance and the type number. The necessary amount of oxygen in the look-up table may in turn be based on earlier experiments with a similar battery type. It should be noted that data regarding the temperature of the battery module is important since the internal resistance varies as a function of temperature and in order to determine the correct amount of oxygen to be filled, the measured voltage drop during discharge needs to be normalized based on the temperature.

According to another alternative the control unit 14 obtains from the look-up table data necessary to calculate the amount of oxygen. The data in the look-up table may be the number of battery cells 2 in the battery module 1, the temperature and the number of battery cells 2, and optionally the volume of the common gas space 5 included when obtaining the internal resistance.

The method may also comprise an optional fifth step S50 of determining a voltage indication over each battery cell U_{c}. The voltage indication may be an open circuit voltage, OCV, over the battery module at the measured temperature or a state of charge, SOC, measure indicating the that it is safe to add oxygen to the battery module. In this example OCV will be used and the determination in step S50 is performed by measuring the open circuit voltage over the battery module, Uₘ, having a plurality of battery cells 2 and dividing the voltage over the battery module with the number of battery cells in the battery module. Thereafter, it is determined whether the battery cell open circuit voltage, U_{c}, is within a predetermined voltage interval, Uₜ₀<U_{c}<Uₜ₁. Also, in this case it is necessary for the control unit 14 to have information on the number of battery cells 2 included in the voltage measurement. If it is determined in a sixth step S60 that the voltage is within the predetermined voltage interval, it is determined that it is safe to fill oxygen into the battery module 1, as indicated by a seventh step S70, which comprises filling of the battery module 1 with the determined amount of oxygen. On the other hand if the battery cell voltage is not within the voltage interval the optional step of adjusting, step S62, the battery cell voltage of the battery module is performed before repeating step S50. This means that if the battery cell voltage is higher or equal to an upper voltage indication threshold, U_{c}≥Uₜ₁, the battery module is discharged (step S64). The discharge step may be performed either by actively discharge the battery module, or wait a certain time period to allow the battery module to self discharge. If the battery cell voltage is lower or equal to a lower voltage indication threshold U_{c}≤Uₜ₀, the battery module is charged (step S66). It is advantageous to perform these optional steps, S50, S60 and S62, in order to reduce the risk for fire in case oxygen is filled into the battery module when the voltage is too high or too low, this may be caused by the fact that the oxygen recombination rate becomes too high at high voltages over the battery cells. If the battery cell voltage becomes too low the oxygen reacts directly with the negative electrode that is unprotected from intercalated hydrogen.

During filling, the temperature of the battery module is monitored in step S72 to prevent the temperature of the battery module to exceed an upper temperature limit, e.g. 40 degrees Celsius, during oxygen filling. Normally, oxygen is initially filled into the battery module at an initial flow rate, e.g. 20 liters/hour, and if the temperature reaches the upper temperature limit, the control unit 14 regulates the flow rate of oxygen to a lower flow rate as illustrated in the examples below.

The method may comprise an additional optional step S74 in which the control unit interrupts the filling if the flow rate is less than a lower limit, e.g. less than an absolute value (such as 2 liters/hour) or less than a percentage of the initial flow rate (such as 10% of the initial flow rate). The filling is interrupted while the temperature of the battery module decreases and the filling can commence when the temperature is below a predetermined threshold, e.g. 90% of the upper temperature limit.

When filling the battery module with oxygen at a high filling rate, e.g. 30 L/h, in order to decrease the filling time, the temperature increases more rapidly and reaches the upper temperature limit faster which in turn requires the flow rate to be decreased. When the initial flow rate is 20 L/h, the lowest filling time is achieved when the battery temperature is around 24 degrees Celsius. Also, the filling time increases exponentially as a function of temperature when temperature is above 24 degrees Celsius.

In addition to steps S72 and S74, the method may further comprise the additional step of monitoring an internal pressure in the at least one battery cell when filling the battery module with oxygen; and regulating the oxygen filling flow rate based on the monitored internal pressure to avoid exceeding an upper pressure limit. The upper pressure limit may be selected to be 3 bar.

In the optional eight step S80, the control unit 14 checks that the filling is complete, if not step S70 is repeated until the filling is complete.

FIG. 3 is a diagram illustrating the resistance ratio (x-axis) as a function of number of times the battery module has been filled with oxygen after cycling, also known as “refills” (y-axis) containing the experimental values from table 1. As can be seen from the graph, the result is a linear relationship expresses as:

$$y = - 2 x + 8 \qquad ( Eq 1 )$$

The battery may be filled with oxygen more times when the filling is performed at a lower resistance ratio (i.e. less aged battery).

FIG. 4 is a diagram illustrating the resistance ratio (x-axis) as a function of total cycle life (y-axis). As can be seen from the graph, the result is also a linear relationship expresses as:

$$y = - 451.7 x + 334 5.7 \qquad ( Eq 2 )$$

Total cycle life reduces with the increasing of resistance ratio. Thus, it is better to perform filling of oxygen as early as possible to achieve a higher number of total cycle life.

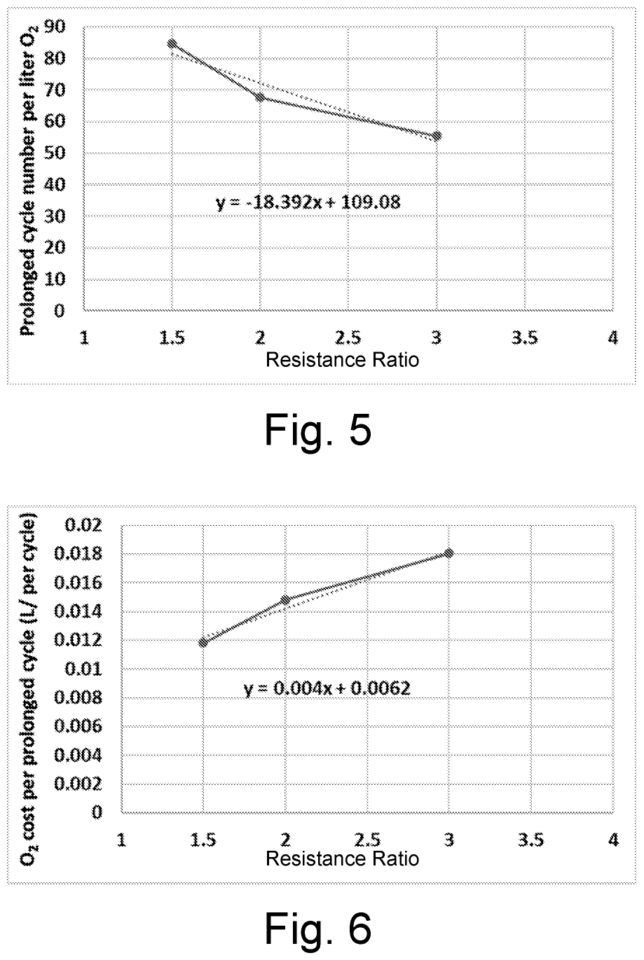

FIG. 5 is a graph illustrating resistance ratio (x-axis) as a function of prolonged cycle life number per liter of added oxygen (y-axis). The relationship may be estimated as a linear function (as illustrated by the dotted line) expressed as:

$$y = - 18.392 x + 109 \text{.08} \qquad ( Eq 3 )$$

The experimental data reveals higher number of prolonged cycle life per liter addition of oxygen, O₂, at lower resistance ratio.

FIG. 6 is a graph illustrating resistance ratio (x-axis) as a function of O₂ cost per prolonged cycle (y-axis). The relationship may be estimated as a linear function (as illustrated by the dotted line) expressed as:

$$y = 0.004 x + 0.0 \; 062 \qquad ( Eq 4 )$$

The experimental data reveals a less O2 volume cost per prolonged cycle at lower resistance ratio.

Based on data shown in FIGS. 3-6, higher number of cycles when filling of oxygen is performed as early as possible and more frequently. Also, more cycle life may be achieved at a lower cost.

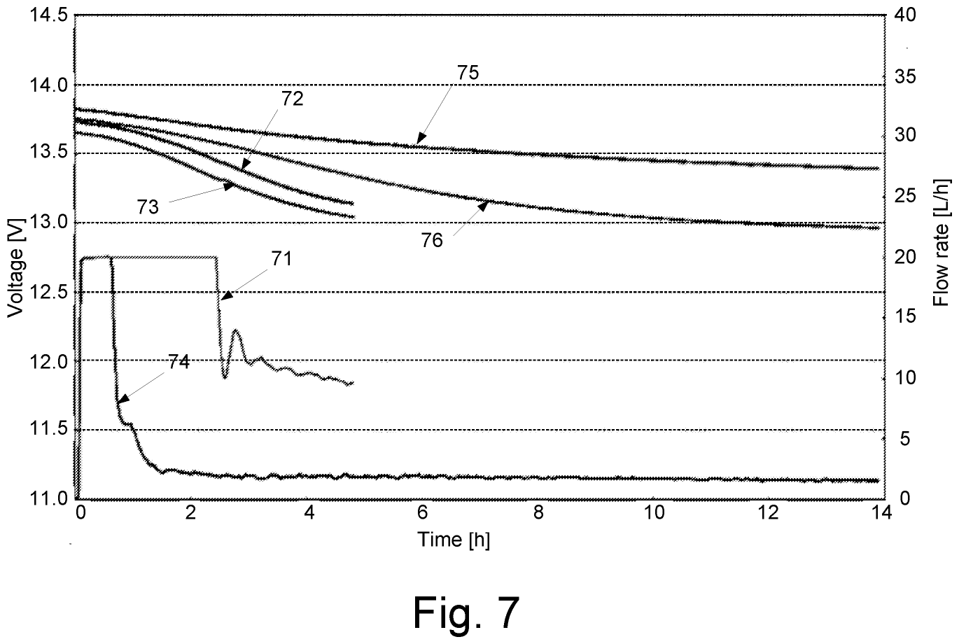

FIG. 7 is a graph related to the flow rate of oxygen when filling oxygen into a battery pack comprising a plurality of battery modules, which reveals that the flow rate may influence the performance of the battery pack.

In order to investigate how the flow rate influences the performance, experiments were initiated with the focus on calculating oxygen filling time based on ambient temperature and flow regulation when battery pack temperature reaches an upper temperature limit during refill.

The battery pack temperature will increase during oxygen filling due to internal chemical reactions within each battery cell in the battery modules of the battery pack. In the experiments, the upper temperature limit was set to 40 degrees Celsius and the initial flow rate during filling oxygen was set to 20 liters/hour, L/h. When the battery pack temperature reached the upper temperature limit, the flow is regulated to prevent the battery pack temperature to exceed the upper temperature limit.

### Experiment 1

Ambient temperature is set to 14 degrees Celsius, and the battery pack initially is filled with oxygen at a flow rate of 20 L/h and the flow rate drops to approximately 10 L/h to regulate the heat generated during filling when the battery pack temperature reaches 40 degrees Celsius. The flow rate is illustrated by curve 71 in FIG. 7. Curve 72 shows the maximum voltage and curve 73 shows the minimum voltage of the battery modules within the battery pack during filling. Curves 72 and 73 behave similarly which is an indication that the flow rate does not affect the performance of individual battery modules in a battery pack.

### Experiment 2

Ambient temperature is set to 30 degrees Celsius, and the battery pack initially is filled with oxygen at a flow rate of 20 L/h and the flow rate drops to approximately 2 L/h to regulate the heat generated during filling when the battery pack temperature reaches 40 degrees Celsius. The flow rate is illustrated by curve 74 in FIG. 7. Curve 75 shows the maximum voltage and curve 76 shows the minimum voltage of the battery modules within the battery pack during filling. Curves 75 and 76 behave differently which is an indication that the flow rate affects the performance of individual battery modules in a battery pack.

Curve 76 shows decay of voltage from the battery module which sits in front area of the battery pack, the decay is faster due to more absorption amount of oxygen compare to curve 75 which shows decay of voltage from the module which sits in back area of the battery pack.

Thus, a low flow rate may cause uneven oxygen amount absorption of modules at different positions in a pack. The reason for this is that the flow of oxygen is too low to reach all modules with equal amount of O₂.

In the published PCT application WO2021/01749 A1, some boundary conditions have been mentioned that may be observed when filling oxygen into a NiMH battery module. For instance the open circuit voltage, OCV, of each battery cell may be within a defined voltage range, 1.30-1.39 V/cell to reduce the risk of fire when filling oxygen. If the OCV is outside the voltage range, the cell voltage needs to be adjusted by charging/discharging the battery module before filling the battery module.

The present disclose relates to a method for filling oxygen into a nickel metal hydride, NiMH, battery module comprising at least one battery cell, the battery module having a casing encompassing the at least one battery cell and a gas space. Each battery cell in the battery module comprises a first electrode, a second electrode, a porous separator, and an aqueous alkaline electrolyte arranged between the first electrode and the second electrode, wherein the porous separator, the first electrode and the second electrode are configured to allow exchange of hydrogen and oxygen by allowing gas to migrate between the electrodes, and wherein the casing further comprises an inlet for adding oxygen to the gas space of the at least one battery cell. The method comprises the steps of regularly determine present internal resistance of the at least one battery cell of the battery module to calculate a resistance ratio, R, in relation to an initial internal resistance of the at least one battery cell of the battery module; and filling the battery module with oxygen when the resistance ratio, R, is higher than a maximum value, Rmax.

According to some embodiments, battery module comprises multiple battery cells and the gas space of each battery cell are in gaseous connection to form a common gas space wherein the inlet is configured to add oxygen to the common gas space.

According to some embodiments, the step of filling the battery module with oxygen is performed when the resistance ratio, R, is equal to, or less than, 2.

According to some embodiments, the method further comprises monitoring the battery module temperature and initiating filling of oxygen at an initial flow rate; and regulating the oxygen filling flow rate based on the monitored battery module temperature to avoid exceeding an upper temperature limit.

According to some embodiments, the method further comprises monitoring an internal pressure in the at least one battery cell when filling the battery module with oxygen; and regulating the oxygen filling flow rate based on the monitored internal pressure to avoid exceeding an upper pressure limit. As an example, the upper pressure limit is 3 bar.

According to some embodiments, the method further comprises interrupting the step of filling the battery module with oxygen when the oxygen flow rate is regulated to a level corresponding to less than 10% of the initial flow rate; and restarting the step of filling the battery module with oxygen when the battery module temperature is less than 90% of the upper temperature limit.

The present disclosure also relates to a computer program for filling oxygen into a battery module, comprising instructions which, when executed on at least one processor 14′, cause the at least one processor 14′ to carry out the method described above. The present disclosure also relates to a computer-readable storage medium carrying the computer program for reconditioning a battery module.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

1. A method for filling oxygen into a nickel metal hydride, NiMH, battery module with at least one battery cell, the battery module having a casing encompassing the at least one battery cell and a gas space, wherein each battery cell in the battery module has a first electrode, a second electrode, a porous separator, and an aqueous alkaline electrolyte arranged between the first electrode and the second electrode, wherein the porous separator, the first electrode and the second electrode are configured to allow exchange of hydrogen and oxygen by allowing gas to migrate between the electrodes, and wherein the casing has an inlet for adding oxygen to the gas space of the at least one battery cell, the method comprising:
regularly determining present internal resistance of the at least one battery cell of the battery module to calculate a resistance ratio, R, in relation to an initial internal resistance of the at least one battery cell of the battery module;
filling the battery module with oxygen when the resistance ratio, R, is higher than a maximum value, Rmax;
monitoring battery module temperature and initiating filling of oxygen at an initial flow rate; and
regulating the oxygen filling flow rate based on the monitored battery module temperature to avoid exceeding an upper temperature limit.

2. The method according to claim 1, wherein the battery module comprises multiple battery cells and the gas space of each battery cell are in gaseous connection to form a common gas space and the inlet is configured to add the gas to the common gas space.

3. The method according to claim 1, wherein the step of filling the battery module with oxygen is performed when the resistance ratio, R, is equal to, or less than, 2.

4. The method according to claim 1, further comprising:
monitoring an internal pressure in the at least one battery cell when filling the battery module with oxygen; and
regulating the oxygen filling flow rate based on the monitored internal pressure to avoid exceeding an upper pressure limit.

5. The method according to claim 4, wherein the upper pressure limit is 3 bar.

6. The method according to claim 1, further comprising:
interrupting the filling of the battery module with oxygen when the oxygen flow rate is regulated to a level corresponding to less than 10% of the initial flow rate; and
restarting the filling of the battery module with oxygen when the battery module temperature is less than 90% of the upper temperature limit.

7. A computer program for reconditioning a battery module, comprising instructions which, when executed on at least one processor, cause the at least one processor to carry out the method according to claim 1.

8. A computer-readable storage medium carrying a computer program for reconditioning a battery module according to claim 7.
